(19) United States
(12) Patent Application Publication
(10) Pub. No.: US 2011/0102627 A1
(43) Pub. Date: May 5, 2011

(54) IMAGE PROCESSING APPARATUS WHICH SETS A REGION OF INTEREST WITHIN A FRAME IMAGE AND IMAGE PICKUP APPARATUS USING THE IMAGE PROCESSING APPARATUS

(76) Inventors: Shigeyuki Okada, Osaka (JP); Yasuo Ishii, Osaka (JP); Yukio Mori, Osaka (JP)

(21) Appl. No.: 13/003,689

(22) PCT Filed: Jul. 2, 2009
(86) PCT No.: PCT/JP2009/003081

§ 371 Date: Jan. 11, 2011

(30) Foreign Application Priority Data
Jul. 11, 2008 (JP) 2008-181072

(51) Int. Cl. H04N 5/228

(52) U.S. Cl. 348/222.1; 348/E05.031

(57) ABSTRACT

A region-of-interest setting unit sets a region of interest within each frame image picked up contiguously. A coding unit codes entire-region moving images where the frame images continue, and region-of-interest moving images where images of regions of interest set by the region-of-interest setting unit continue. A recording unit records coded data of the entire-region moving images and coded data of the region-of-interest moving images both coded by the coding unit in a manner such that the coded data of the entire-region moving images and the coded data of the region-of-interest moving images are associated with each other.

### TECHNICAL FIELD

The present invention relates to an image processing apparatus and an image pickup apparatus provided with said image processing apparatus.

### BACKGROUND ART

Digital movie cameras with which average users can readily take moving pictures have been widely in use. In most occasions, an average user, who uses a digital movie camera, takes moving images by tracking a specific object so that the object can stay within a screen. For example, the average users typically take pictures of persons such as their children running in athletic festivals or the like.

### SUMMARY OF INVENTION

If the moving images where the specific object have been captured as an object of interest are to be played back for looking and listening, it is often requested that the object be viewed in a close-up fashion. At the same time, it is often requested that images with more wider background be viewed and listened to. In particular, in the frames where the object is not captured, the latter request is more popular. In order to produce moving images that meet such requests, complicated editing must be done. For example, the following work needs to be done. That is, the moving images captured and coded are decoded and reproduced, and a region containing the object is selected from arbitrary frame images by user operations. Then the image of the thus selected region is recoded and replaced with original frame images.

An image processing apparatus according to one embodiment of the invention comprises: a region-of-interest setting unit which sets a region of interest within a frame image picked up contiguously; a coding unit which codes entire-region moving images where the frame image continues, and region-of-interest moving images where an image of the region of interest set by the region-of-interest setting unit continues; and a recording unit which records coded data of the entire-region moving images coded by the coding unit and coded data of the region-of-interest moving images coded by the coding unit in a manner such that the coded data of the entire-region moving images and the coded data of the region-of-interest moving images are associated with each other.

Another embodiment of the present invention relates also to an image processing apparatus. This apparatus comprises a region-of-interest setting unit which sets a region of interest within a frame image picked up contiguously; a first coding unit which codes entire-region moving images where the frame image continues; a second coding unit which codes region-of-interest moving images where an image of the region of interest set by the region-of-interest setting unit continues, in parallel with a coding of the entire-region moving images performed by the first coding unit; and a recording unit which records coded data of the entire-region moving images coded by the first coding unit and coded data of the region-of-interest moving images coded by the second coding unit in a manner such that the coded data of the entire-region moving images and the coded data of the region-of-interest moving images are associated with each other.

Optional combinations of the aforementioned constituting elements, and implementations of the invention in the form of methods, apparatuses, systems, recording media, computer programs and so forth may also be effective as additional modes of the present invention.

### BRIEF DESCRIPTION OF THE DRAWINGS

[FIG. 1]

FIG. 1 shows a structure of an image pickup apparatus according to a first embodiment of the present invention;

[FIG. 2]

FIG. 2 shows a structure of a region-of-interest setting unit according to a first embodiment of the present invention;

[FIG. 3]

FIG. 3 shows a frame image picked up by an image pickup unit according to a first embodiment of the present invention, a frame image of entire-region moving images, and a unit image of region-of-interest moving images;

[FIG. 4]

FIG. 4 shows a structure of an image reproduction apparatus according to a second embodiment of the present invention;

[FIG. 5]

FIG. 5 shows an exemplary display by a display unit according to a second embodiment of the present invention;

[FIG. 6]

FIG. 6 shows a structure of an image pickup apparatus according to a first modification of a first embodiment of the present invention;

[FIG. 7]

FIG. 7 shows a structure of an image pickup apparatus according to a second modification of a first embodiment of the present invention; and

[FIG. 8]

FIG. 8 shows a frame image picked up by an image pickup unit according to a second modification of a first embodiment of the present invention, a first-region image and a second-region image.

### BEST MODE FOR CARRYING OUT THE INVENTION

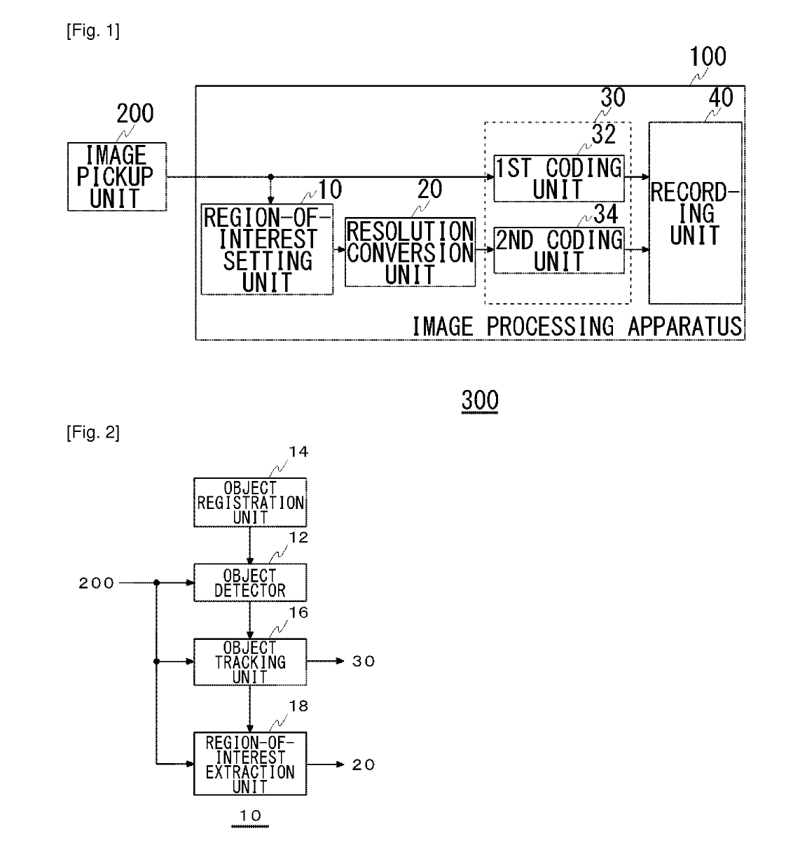

FIG. 1 shows a structure of an image pickup apparatus 300 according to a first embodiment of the present invention. The image pickup apparatus 300 according to the first embodiment comprises an image pickup unit 200 and an image processing apparatus 100. The image pickup unit 200 acquires frame images continuously and supplies them to the image processing apparatus 100 as moving images. The image pickup unit 200 is provided with not-shown solid-state image pickup devices, such as CCD (Charge-Coupled Devices) sensors and CMOS (Complementary Metal-Oxide Semiconductor) image sensors, and a not-shown signal processing circuit that processes signals outputted from the solid state image pickup devices. This signal processing circuit can convert analog three primary color signals R, G and B into digital luminance signal Y and digital color-difference signals Cr and Cb.

The image processing apparatus 100 processes the frame images acquired by the image pickup unit 200. The image processing apparatus 100 includes a region-of-interest setting unit 10, a resolution conversion unit 20, a coding unit 30, and a recording unit 40. The structure of the image processing apparatus 100 may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

The region-of-interest setting unit 10 sets a region of interest or regions of interest within the frame images which are continuously picked up by the image pickup unit 200. The region of interest may be set for all of the frame images supplied from the image pickup unit 200 or may be set for part of the frame images. In the latter case, the region of interest may be set only during a period when the setting of regions of interest is specified due to a user operation.

The region-of-interest setting unit 10 supplies an image for the thus set region of interest to the resolution conversion unit 20. If this image for the region of interest is not subjected to a resolution conversion processing performed by the resolution conversion unit 20, the image will be supplied to the coding unit 30. The detailed description of the region-of-interest setting unit 10 will be discussed later. The detailed description of the resolution conversion unit 20 will also be discussed later.

The coding unit 30 codes both entire-region moving images, supplied from the image pickup unit 200, where frame images continue successively and region-of-interest moving images, set by the region-of-interest setting unit 10, where region-of-interest images continue successively. The coding unit 30 compresses and codes the aforementioned entire-region moving images and region-of-interest moving images according a predetermined standard. For example, the images are compressed and coded in compliance with the standard of H.264/AVC, H.264/SVC, MPEG-2, MPEG-4 or the like.

The coding unit 30 may code the entire-region moving images and the region-of-interest moving images by the use of a single hardware encoder in a time sharing manner. Alternatively, the coding unit 30 may code the entire-region moving images and the region-of-interest moving images in parallel by the use of two hardware encoders. Suppose that the former case is applied. Then a not-shown buffer is provided and the region-of-interest moving images are temporarily stored in the buffer until the coding of the entire-region moving images has completed. After completion of the coding thereof, the region-of-interest moving images can be retrieved from the buffer and coded.

Suppose that the latter case is applied. Then the coding unit 30 is configured by two hardware encoders which are a first coding unit 32 and a second coding unit 34. The first coding unit 32 codes the entire-region moving images. The second coding unit 34 codes the region-of-interest moving images in parallel with the coding of the entire-region moving images by the first coding unit 32. If region-of-interest images are to be acquired from all frame images, the number of images to be coded matches both in the entire-region moving images and the region-of-interest moving images and therefore the coding may be performed in such a manner that the first coding unit 32 and the second coding unit 34 are synchronized together.

The recording unit 40, which is provided with a not-shown recording medium, records the coded data of the entire-region moving images and the coded data of the region-of-interest moving images in such a manner that these two sets of coded data are associated with each other. A memory card, a hard disk, an optical disk, or the like may be used as this recording medium. The recording medium may be not only installed or mounted within the image pickup apparatus 300 but also installed on a network.

The recording unit 40 may combine the entire-region moving images with the region-of-interest moving images so as to produce a file or may set them as separate files. In either case, it is only necessary that each frame image in the entire-moving images is associated with each unit image, which corresponds to said each frame image, in the region-of-interest moving images. For example, region-of-interest images are to be acquired from all of the frame images, identical serial numbers may be given to both frame images in the entire-region moving images and those associated with unit images in the region-of-interest moving images.

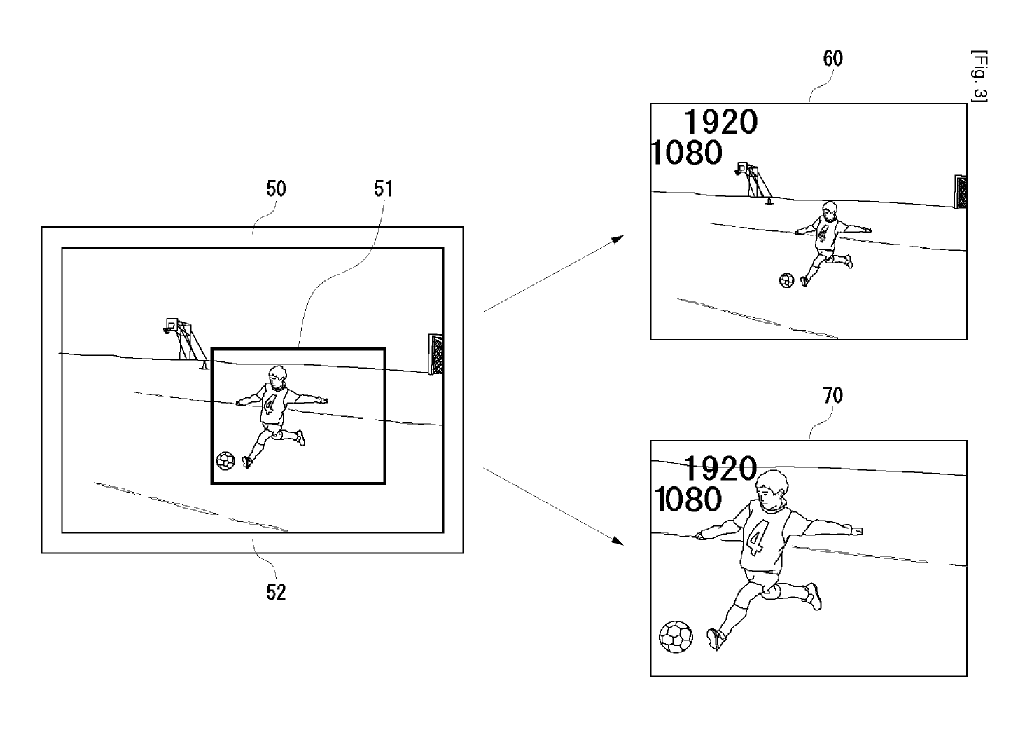

FIG. 2 shows a structure of the region-of-interest setting unit 10 according to the first embodiment of the present invention. The region-of-interest setting unit 10 includes an object detector 12, an object registration unit 14, an object tracking unit 16, and a region-of-interest extraction unit 18. The object detector 12 detects a specific object from within a frame image. The object registration unit 14 enrolls the specific object in the object detector 12. For example, the face of a child is picked up using the image pickup unit 200 and then can be enrolled in the object detector 12. Examples of an object include a person, a pet animal like a dog or cat, a moving object like an automobile or electric train, and so forth. Hereinbelow, an example will be explained where the object is a person or persons.

A person as the object maybe a person detected first from within the frame image after the moving images have begun to be picked up or a specific person enrolled by the object registration unit 14. In the former case, dictionary data to detect a person in general is used. Dictionary data for the detection of the registered specific person is used in the latter case. The person detected first or the registered specific person is an object to be tracked within subsequent frame images.

The object detector 12 can identify a person by detecting a face in the frame image. The object detector 12 sets a body region below a face region containing the detected face. The size of the body region is set proportionally to the size of the face region. A person region that contains the entire body of a person may be set as an object to be tracked.

The face detection processing may be done using a known method and not limited to any particular method. For example, an edge detection method, a boosting method, a hue extraction method or skin color extraction method may be used for the face detection method.

In the edge detection method, various edge features are extracted from a face region including the contour of eyes, nose, mouth and face in a face image where the size of a face or a gray value thereof is normalized beforehand. A feature quantity which is effective in identifying whether an object is a face or not is learned based on a statistical technique. In this manner, a face discriminator is constructed. As for the face of a specific person registered by the object registration unit 14, a face discriminator is constructed from its facial image.

To detect a face from within an input image, the similar feature quantity is extracted while raster scanning is performed, with the size of face normalized at the time of learning, starting from an edge of the input image. From this feature quantity, the face discriminator determines whether the region is a face or not. For example, a horizontal edge, a vertical edge, a diagonal right edge, a diagonal left edge and the like are each used as the feature quantity. If the face is not detected at all, the input image is reduced by a certain ratio, and the reduced image is raster-scanned similarly to the above to detect a face. Repeating such a processing leads to finding a face of arbitrary size from within the image.

The object tracking unit 16 tracks the specific object, detected by the object detector 12, in subsequent frame images. The object tracking unit 16 can specify whether the tracking has been successful or not for each frame image. In such a case, the coding unit 30 appends information on the success or failure of the tracking to a header region or a region where a user is allowed to write (hereinafter referred to as “user region”) of at least one of each frame of the aforementioned entire-region moving images and each unit image of the aforementioned region-of-interest moving images, as tracking information. Note that the success or failure of the tracking for each frame image maybe described all together in a sequence header region or GOP (Group of Pictures) header region instead of a picture header region.

The object tracking unit 16 can track the specific object based on the color information on the object. In the above described example, the object is tracked in a manner that a color similar to the color of the aforementioned body region is searched within successive frame images. If a detection result of the face detected by the object detector 12 within the successive frame images is added, the accuracy of tracking can be enhanced.

The success or failure of the tracking is determined as follows. That is, the object tracking unit 16 determines that the tracking is successful for a frame image if an object to be tracked is contained in the frame image and determines that the tracking is a failure if the object to be tracked is not contained in the frame image. Here, the object may be tracked in units of the aforementioned face region or in units of the aforementioned person region.

For each frame image, the object tracking unit 16 can generate a flag indicating whether the tracking has been successful or not. In this case, the coding unit 30 describes this flag in a header region or a user region of at least one of each frame image and each unit image, as the tracking information.

The object tracking unit 16 can identify a frame image within which the specific object does not lie. In such a case, the coding unit 30 appends information indicating that the specific object does lie in the frame image, to the aforementioned header region or user region as the tracking information. The object tracking unit 16 can identify a frame image where the specific object has come back into the frame image. In this case, the coding unit 30 appends information indicating that the specific image has come back into the frame image, to the aforementioned header region or user region, as the tracking information.

The region-of-interest extraction unit 18 extracts an image that contains therein a specific object which is detected by the object detector 12 and is tracked by the object tracking unit 16, as an image of the region-of-interest. Though, in FIG. 1, frame images are sorted out into two different types of them, namely frame images for entire-region moving images and those for region-of-interest moving images, and therefore the expression like “the region-of-interest image is extracted” is used, this is equivalent to duplicating a region-of-interest image in the frame image in terms of the original frame image before the classification.

The region of interest may be a rectangular region that contains the entirety of an object and its peripheral region. In such a case, the aspect ratio of the rectangular region is preferably fixed. Further, the aspect ratio thereof may be set practically equal to the aspect ratio of a frame image in the entire-region moving images. This setting proves effective if the size of the unit image in the region-of-interest moving images is associated with the size of a frame image in the entire-region moving images as will be described later.

A designer may arbitrarily set how much regions must be ensured as peripheral regions around a given region of interest in up and down directions (vertical direction) and left and right directions (horizontal direction) of an object, respectively, in terms of what ratio thereof relative to the size of the object. For example, in order to meet the aforementioned aspect ratio, the peripheral region may be set in such a manner that the ratio thereof relative to the size of the object is larger in the left and right directions of the object than in the up and down directions thereof.

The region-of-interest extraction unit 18 also sets a region of interest in a frame image where the specific object is not detected and the tracking of the object has ended up in failure, and extracts an image of the region of interest. The region-of-interest extraction unit 18 may set this region of interest in the same position as a region of interest set in the last frame image where the tracking has been successful. Or this region-of-interest may be set in a central position of the frame image. Also, the entire region of a frame image may be set as the region of interest. Since the region of interest is also set in the frame image where the tracking of the object fails, the number of frame images in the entire-region moving images can match the number of unit images in the region-of-interest moving images.

Now, refer back to FIG. 1. For the purpose of keeping the size of unit images of region-of-interest moving images, to be coded by the coding unit 30, constant, the resolution conversion unit 20 converts the resolution of the unit images thereof. If the size of regions-of-interest varies according as the size of an object changes, the size of the unit images of region-of-interest moving images will also vary. In this case, for the purpose of creating the unit images of uniform size (preset size), the resolution conversion unit 20 enlarges a unit image if the size of the unit image is smaller than the preset size, whereas it reduces the unit image if the size thereof is larger than the preset size.

The resolution conversion unit 20 can enlarge a unit image to be enlarged, through a spatial pixel interpolation processing. A simple linear interpolation processing or an interpolation processing using FIR filter may be employed as this pixel interpolation processing.

The resolution conversion unit 20 may enlarge a unit image to be enlarged, by the use of super-resolution processing. Super-resolution processing is a technique where an image whose resolution is higher than a plurality of images is generated from the plurality of low-resolution images having fine displacements from one another. The detailed description of super-resolution processing is disclosed in an article, for example, “Super Resolution Processing by Plural Number of Lower Resolution Images” by Shin Aoki, Ricoh Technical Report No. 24, November, 1998. A partial image of frame image which is temporally adjacent to the image frame from which the aforementioned unit image to be enlarged is extracted may be used as the aforementioned plurality of images having fine displacements. The position of the partial image is associated with the extracted position of the unit image.

The resolution conversion unit 20 can reduce a unit image to be reduced, through a thinning processing. Specifically, the pixel data of the unit image are thinned out according to a reduction ratio. The resolution conversion unit 20 may reduce a unit image to be reduced, by the use of a filter processing. For instance, the image is reduced in a manner that the averaged value of a plurality of neighboring pixel data is calculated and the plurality of pixel data are converted into a single piece of pixel data.

The resolution conversion unit 20 may convert the resolution of a unit image of region-of-interest moving images in a manner such that the size of the unit image of region-of-interest moving images corresponds to the size of a frame image of entire-region moving images to be coded by the coding unit 30. For instance, both the sizes may be matched with each other or may be approximately identical to each other. In such a case, the size of the frame image of entire-region moving images may be set as the size of the unit image to be kept uniform. Also, both the sizes may be set to values such that one size is proportional to the other. The aspect ratio of this frame image may be set to 16:9 and the aspect ratio of this unit image may be set to 4:3.

FIG. 3 shows a frame image 50 picked up by the image pickup unit 200 according to the first embodiment, a frame image 60 of entire-region moving images, and a unit image 70 of region-of-interest moving images. The resolution of the picked-up frame image 50 corresponds to the number of light receiving elements in the solid state image pickup devices contained in the image pickup unit 200. An image pickup region on which multiple light receiving elements are disposed has an effective pixel region and a shake-correction region 52 provided on the periphery of the effective pixel region. A region of interest 51 is set within the picked-up frame image 50 by the region-of-interest setting unit 10. Here, a child, wearing the number 4, who is about to kick the ball is recognized as an object, and a region containing this object is set as the region of interest 51.

FIG. 3 illustrates an example where the size of the frame image 60 of entire-region moving images and the size of the unit image 70 of region-of-interest moving images are matched with each other. The size of both the images is set to the 1080i (1920×1080 pixels) size.

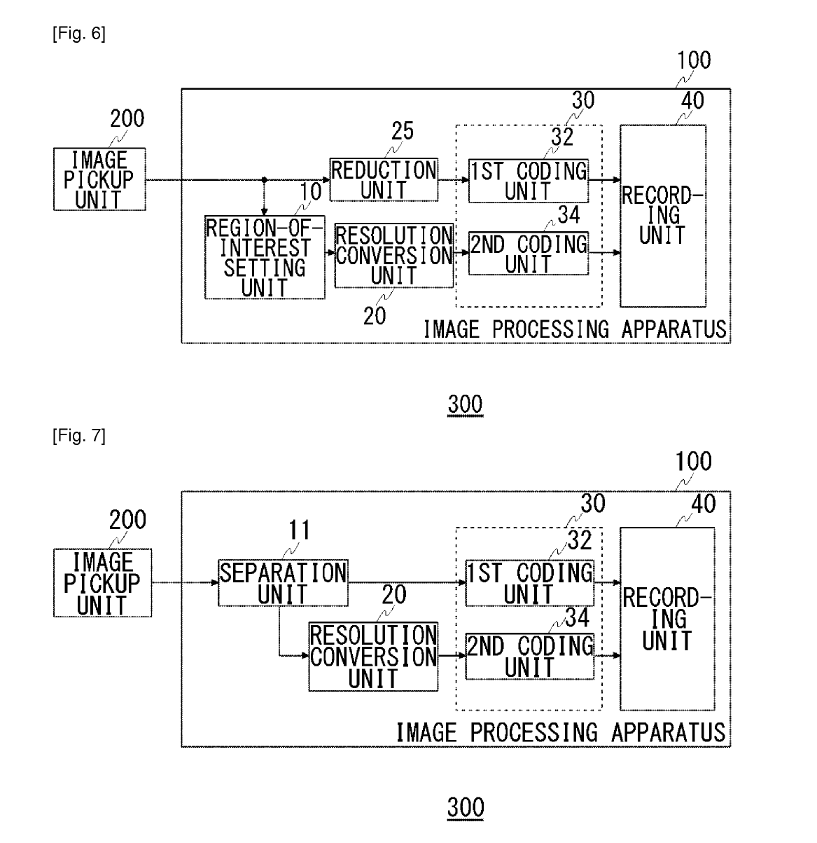

When moving images are shot, there are cases where a frame image whose number of pixels is less than the effective pixels of the solid state image pickup devices are generated for the purpose of mitigating the image processing load. This processing for reducing the number of pixels may be carried out by a not-shown signal processing circuit in the image pickup unit 200 or a not-shown reduction unit in the image processing apparatus 100. Or this processing may be carried out by both the signal processing circuit and the reduction unit. If the thinning processing or filter processing is to be carried out within the image processing apparatus 100, a reduction unit 25 will be provided preceding the first coding unit 32 in the image processing apparatus 100 shown in FIG. 1 (See FIG. 6 described later).

According to the first embodiment as described above, the coded data of entire-region moving images and the coded data of region-of-interest moving images which are associated with each other can be generated. Thus, the moving images with which a specific object can be displayed in an emphasized or preferential manner can be easily obtained without going through cumbersome processes.

Also, since the size of the frame image of entire-region moving images and the size of the unit image of region-of-interest moving images are appropriately associated with each other, reproduction display and editing can be done easily. For instance, when either a frame image of entire-region moving images or a unit image of region-of-interest moving images is displayed by switching them as appropriate, there is no need to convert the resolution. Also, when another moving images are generated by combining, as appropriate, frame images of entire-region moving images and unit images of region-of-interest moving images, there is no need to convert the resolution.

Since the information on whether the tracking has been successful or not is appended to the header region or user region of at least one of each unit frame of region-of-interest moving images and each frame image of entire-region moving images, information useful at a reproduction side or editing side can be provided. Exemplary utilizations will be discussed later.

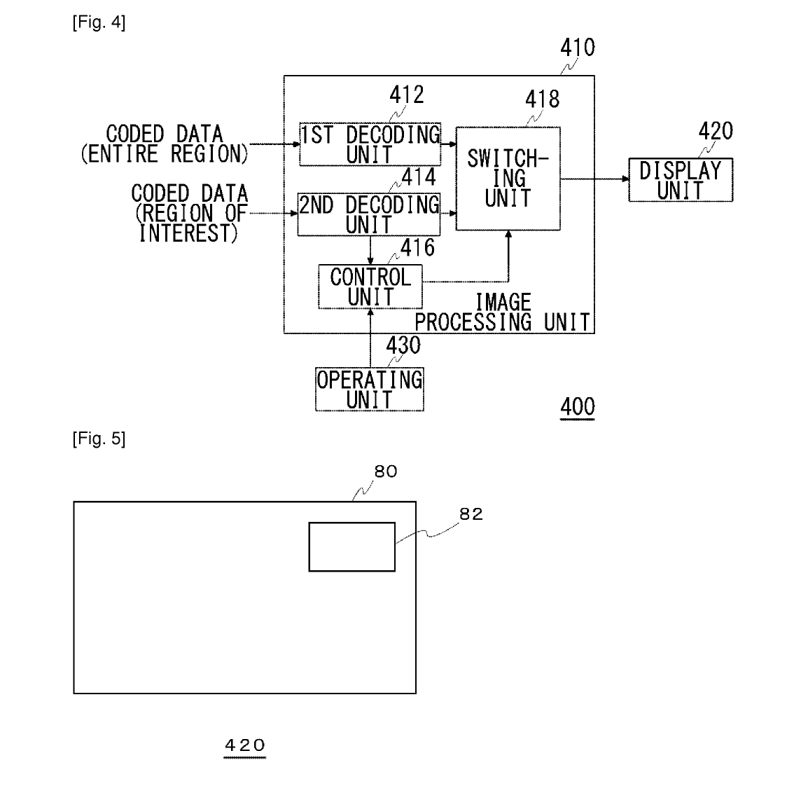

FIG. 4 shows a structure of an image reproduction apparatus 400 according to a second embodiment of the present invention. The image reproduction apparatus 400 according to the second embodiment may be so mounted as to achieve a function of the image pickup apparatus 300 or may be configured as a stand-alone equipment. The image reproduction apparatus 400 includes an image processing unit 410, a display unit 420, and an operating unit 430.

The image processing unit 410 processes the coded data of entire-region moving images and the coded data of region-of-interest moving images produced by the image processing apparatus 100 according to the first embodiment. The image processing unit 410 includes a first decoding unit 412, a second decoding unit 414, a control unit 416, and a switching unit 418.

Assume, in the following description, that each frame image of entire-region moving images and each unit image of region-of-interest moving images are synchronized with each other and the sizes of both the images are identical. Also, assume that the tracking information indicating whether the tracking has been successful or not is appended to the header region or user region of each unit image of region-of-interest moving images.

The first decoding unit 412 and the second decoding unit 414 are structured by separate hardware decoders. The first decoding unit 412 decodes coded data of entire-region moving images. The second decoding unit 414 decodes coded data of region-of-interest moving images. The second decoding unit 414 supplies the information on whether the tracking of the object for each unit image of region-of-interest moving images has been successful or not, to the control unit 416.

The switching unit 418 supplies each frame of entire-region moving images supplied from the first decoding unit 412 and each unit image of region-of-interest moving images supplied from the second decoding unit 414 to the display unit 420 in such a manner that either one of each frame image thereof and each unit image thereof is prioritized over the other. For example, either one of the frame image and the unit image which are synchronized with each other is selected and the selected one is outputted to the display unit 420. Also, of the frame image and the unit image which are synchronized with each other, the resolution of at least one of them is converted so that the size of the prioritized image becomes larger than that of the image not prioritized, and then both the images are outputted to the display unit 420. For example, when the unit image thereof is given priority, the unit image is outputted directly to the display unit 420 as it is, and the frame image thereof is outputted to the display unit 420 after the frame image has been reduced.

The control unit 416 specifies which one of the frame image and the unit image that are synchronized with each other is to be given priority, to the switching unit 418. The control unit 416 can determine which one of them is to be prioritized over the other by referencing the tracking information received from the second decoding unit 414. In such a case, a decision is made as follows. That is, for a unit image for which the tracking is successful, the unit image is given priority; for a unit image for which the tracking is not successful, a frame image associated with said unit image is given priority. If the control unit 416 receives instruction information instructing to specify which one between the frame image and the unit image is to be given priority, from the operating unit 430 prompted by a user operation, the control unit 416 will determine which one of them is to be prioritized according to the instruction information. If the decision based on the tracking information and the decision based on the instruction information are used in combination, the latter will be given priority.

The display unit 420 displays at least either of frame images and unit images continuously supplied from the switching unit 418.

FIG. 5 shows an exemplary display by the display unit 420 according to the second embodiment of the present invention. The display unit 420 has a main window 80 and a sub-window 82. FIG. 5 illustrates an example where the sub-window 82 is provided within the main window 80. Of the frame image and the unit image that are synchronized with each other, the display unit 420 displays the image, whichever is given priority, on the main window 80 and the other image not given priority on the sub-window 82. For example, if the order of preference is determined based on the aforementioned tracking information and if the tracking of an object is successful, the unit image will be displayed on the main window 80 and the frame image will be displayed on the sub-window 82. If, on the other hand, the tracking of the object fails, the frame image will be displayed on the main window 80 and the unit image will be displayed on the sub-window 82.

According to the second embodiment described as above, a specific object can be displayed as approximate in an emphasized or preferential manner by the use of the coded data of entire-region moving images and the coded data of region-of-interest moving images generated in the first embodiment. In particular, if the success or failure of the tracking is specified per frame image, whether the unit image is to be prioritized or the frame image is to be prioritized can be automatically determined.

The present invention has been described based upon illustrative embodiments. These embodiments are intended to be illustrative only and it will be obvious to those skilled in the art that various modifications to the combination of constituting elements and processes could be developed and that such modifications are also within the scope of the present invention.

For example, in the first embodiment, an example has been described where the size of each frame image of entire-region moving images and the size of each unit image of region-of-interest moving images are made identical to each other. In contrast, in a first modification, the size of each frame image of entire-region moving images is set smaller than that of each unit image of region-of-interest moving images.

FIG. 6 shows a structure of the image pickup apparatus 300 according to the first modification of the first embodiment. The structure of this first modification is such that a reduction unit 25 is added into the image processing apparatus 300 according to the basic example as shown in FIG. 1. The reduction unit 25 reduces the frame images supplied from the image pickup unit 200. Similarly to the reduction processing by the resolution conversion unit 20, the frame image can be reduced by the thinning processing or filter processing. In so doing, generated are frame images whose resolution is lower than that of the unit images which have been subjected to the resolution conversion by the resolution conversion unit 20. According to the first modification, the data amount of entire-region moving images can be reduced. When the objet tracking accuracy is high, more of the unit images are used and fewer frame images are used. In such a case, lowering the resolution of the frame images of entire-region moving images has less impact on the overall resolution, so that the use of this first modification can be very effective.

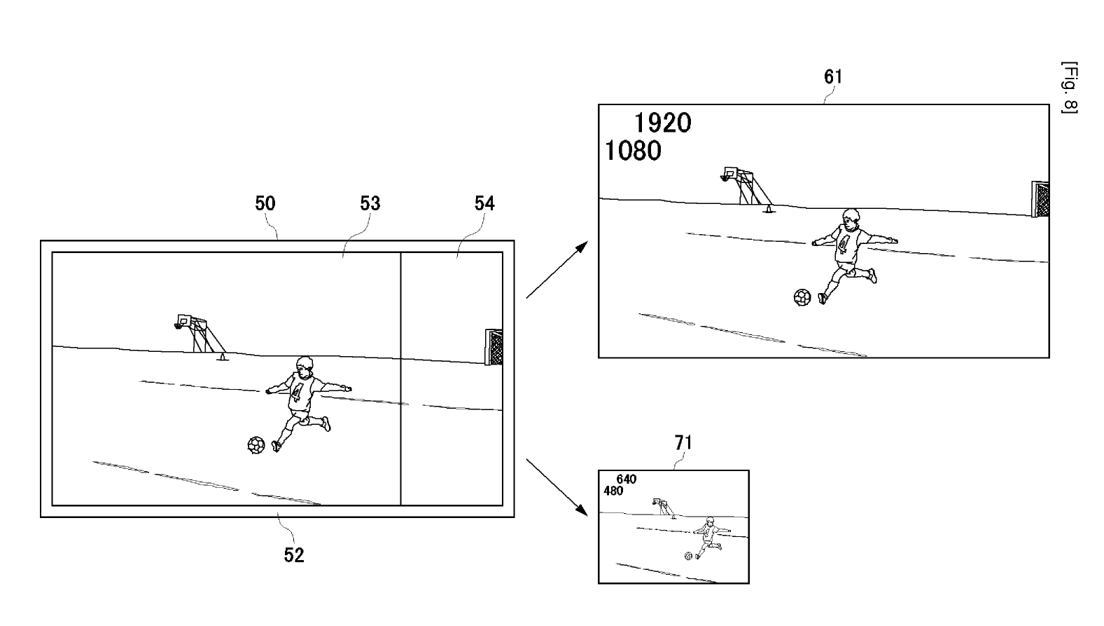

FIG. 7 shows a structure of an image pickup apparatus 300 according to a second modification of the first embodiment. As compared with the image pickup apparatus 300 shown in FIG. 1, the image pickup apparatus 300 according to this second modification of the first embodiment is of a structure such that a separation unit 11 is added and the region-of-interest setting unit 10 is removed. The separation unit 11 outputs first-region images in frame images picked up continuously by the image pickup unit 200, to a coding unit 30 and outputs second-region images in the frame images to a resolution conversion unit 20. Here, the first region may be the entire region of the frame image, and the second region maybe a region where a lateral region of the frame image is partially omitted. More specifically, the aspect ratio of the first region may be 16:9, and the aspect ratio of the second region may be 4:3.

The resolution conversion unit 20 converts the resolution of the second-region image in such a manner that the resolution of the second-region image is lower than that of the first-region image. For example, when the size of the first-region image is set to the 1080i (1920×1080 pixels) size, the resolution conversion unit 20 converts the size of the second-region image to a VGA (640×480) size. More specifically, the pixels of the second-region image of 1080i (1920×1080 pixels) size where a lateral region is partially omitted are thinned out and then converted to a second-region image of VGA (640×480) size.

A coding unit 30 codes first-region moving images where the first-region images continue successively, and second-region moving images where the second-region images continue successively. The second-region moving images are coded with a resolution lower than the resolution of the first-region moving images. A recording unit 40 records the coded data of the first-region moving images coded by the coding unit 30 and the coded data of the second-region moving images coded by the coding unit in such a manner that these two sets of coded data are associated with each other.

FIG. 8 shows a frame image 50, a first-region image 61 and a second-region image 71 which are picked up by an image pickup unit 200 according to the second modification of the first embodiment. A clipping region 53 and a skipped region 54 are contained in a region excluding a shake-correction region 52 of the frame image. Although an example is depicted where the skipped region 54 is set on the extreme right, the skipped region 54 may be set on the extreme left, instead, or may be set on both the extreme left and the extreme right in a divided manner. The separation unit 11 supplies an image of the region excluding the shake-correction region 52 of the frame image 50, to the coding unit 30 as a first-region image 61, and supplies an image of the clipping region 53 to the resolution conversion unit 20. The resolution conversion unit 20 converts an image of the clipping region 53 of 1080i (1920×1080 pixels) size where the skipped region 54 is left out, to the second-region 71 of VGA (640×480) size so as to be supplied to the coding unit 30. The coding unit 30 codes the first-region moving images where the first-region images 61 continue successively, and the second-region moving images where the second-region images continue successively. The recording unit 40 stores the coded data of the first-region moving image as those to be viewed and listened to and stores the coded data of the second-region moving image as those submitted to an Internet site.

According to the second modification as described above, moving images of full-HD image quality with an aspect ratio of 16:9 and those of SD image quality can be compressed and coded simultaneously from each image pickup device. The former moving images can be used for the viewing and listening through a large-scale display (e.g., large screen television at home) and the latter moving images can be used for uploading to an Internet website. If the former moving images only are enrolled in the recording unit 40 after they have been compressed and coded and if they are to be uploaded to an Internet website which is not compatible with these moving images, the trans-codec must be applied to the coded data of these moving images need. By employing this second modification, cumbersome processing like this will be eliminated.

Although a description has been given of an example where the first region and the second region differ from each other, the first region and the second region may be identical to each other. In such a case, two types of moving images with different resolutions but the same contents will be coded.

1. An image processing apparatus, comprising:
a region-of-interest setting unit which sets a region of interest within a frame image picked up contiguously;
a coding unit which codes entire-region moving images where the frame image continues, and region-of-interest moving images where an image of the region of interest set by said region-of-interest setting unit continues; and
a recording unit which records coded data of the entire-region moving images coded by said coding unit and coded data of the region-of-interest moving images coded by said coding unit in a manner such that the coded data of the entire-region moving images and the coded data of the region-of-interest moving images are associated with each other.

2. An image processing apparatus according to claim 1, said region-of-interest setting unit including:
an object detector which detects a specific object from within the frame image;
an object tracking unit which tracks the specific object detected by said object detector within subsequent frame images; and
a region-of-interest extraction unit which extracts an image of a region containing the specific object detected by said object detector and tracked by the object tracking unit, as an image of the region of interest.

3. An image processing apparatus according to claim 2, wherein said object tracking unit specifies whether the tracking has been successful or not for each frame image, and
wherein said coding unit appends information on whether the tracking has been successful or not, to a header region or a user write enable region of at least one of each frame image of the entire-region moving images and each unit image of the region-of-interest moving images.

4. An image processing apparatus according to claim 1, further comprising a resolution conversion unit which converts the resolution of a unit image of the region-of-interest moving image in order to keep the size of the unit image thereof, to be coded by said coding unit, constant.

5. An image processing apparatus according to claim 4, wherein said resolution conversion unit converts the resolution of the unit image in a manner such that the size of the unit image of the region-of-interest moving image corresponds to the size of a frame image of the entire-region moving image to be coded by said coding unit.

6. An image processing apparatus, comprising:
a region-of-interest setting unit which sets a region of interest within a frame image picked up contiguously;
a first coding unit which codes entire-region moving images where the frame image continues;
a second coding unit which codes region-of-interest moving images where an image of the region of interest set by said region-of-interest setting unit continues, in parallel with a coding of the entire-region moving images performed by said first coding unit; and
a recording unit which records coded data of the entire-region moving images coded by said first coding unit and coded data of the region-of-interest moving images coded by said second coding unit in a manner such that the coded data of the entire-region moving images and the coded data of the region-of-interest moving images are associated with each other.

7. An image processing apparatus, comprising:
a coding unit which codes a first-region moving image where a first-region image of each frame image, picked up continuously, continues and a second-region moving image where a second-region image of the each frame image, picked up continuously, continues; and
a recording unit which records coded data of the first-region moving images coded and coded data of the second-region moving images coded by said coding unit in a manner such that the coded data of the first-region moving images and the coded data of the second-region moving images are associated with each other.
wherein the second-region moving images are coded in a manner such that the resolution of the second-region moving images is lower than that of the first-region moving images.

8. An image pickup apparatus, comprising:
an image pickup unit which acquires frame images; and
an image processing apparatus, according to claim 1, which processes the frame images acquired by said image pickup unit.
